(19) United States
(12) Patent Application Publication
(10) Pub. No.: US 2017/0229099 A1
(43) Pub. Date: Aug. 10, 2017

(54) DISPLAY APPARATUS AND METHOD FOR CONTROLLING DISPLAY APPARATUS

(71) Applicant: CANON KABUSHIKI KAISHA, Tokyo (JP)

(72) Inventor: Koji Mito, Koza-gun (JP)

(21) Appl. No.: 15/426,893

(22) Filed: Feb. 7, 2017

(30) Foreign Application Priority Data
Feb. 9, 2016 (JP) 2016-023060

(51) Int. Cl. G09G 5/10

(52) U.S. Cl. CPC G09G 5/10; G09G 2320/0646; G09G 2360/144; G09G 2320/0233; G09G 2340/04

(57) ABSTRACT

A display apparatus 1 of the present disclosure includes a display unit 2 that displays an image on a screen 2a, an area size acquisition unit 107 that acquires a display area size Sr, a luminance range determination unit 108 that determines a settable range of display luminance, using the display area size Sr, a luminance setting unit 109 that sets the display luminance, and a display control unit 113 that controls the display unit 2, and the luminance range determination unit 108 determines a first luminance range as the display luminance range if the display area size Sr is a first size, and determines a second luminance range as the display luminance range if the display area size Sr is a second size larger than the first size, and a luminance at an upper limit of the second luminance range is lower than that of the first luminance range.

### BACKGROUND

Field of the Disclosure

The present disclosure relates to display apparatus that can set display luminance, and a method for controlling the display apparatus.

Description of the Related Art

There is a display apparatus that can display an image of high luminance to display a high-dynamic-range image. In such a display apparatus, a user can set a maximum value of the display luminance displayed on a screen.

On the other hand, if an image of high luminance is displayed on a large screen, the amount of light emission from the screen to the user who is viewing the image is increased. At this point in time, the user may feel glare to reduce the visibility of the screen.

In a display apparatus described in Japanese Patent Laid-Open No. 2011-199658, a technology is disclosed which, when the size of an image displayed on a screen has been changed, controls a display luminance set value set by a user in accordance with the change in the size of the image. Consequently, a change in the brightness of an entire screen can be reduced when the size of an image has been changed.

### SUMMARY

A display apparatus of the present disclosure includes: a display unit configured to display an image on a screen; a first acquisition unit configured to acquire a size of a display area, in which the image is displayed, of the screen; a determination unit configured to determine a settable range of display luminance, using the size of the display area; a setting unit configured to set display luminance of the image to be displayed on the screen, within the range of display luminance determined by the determination unit; and

a control unit configured to control the display unit in such a manner as to display the image at the set display luminance, and if the size of the display area is a first size, the determination unit determines a first range of luminance as the range of display luminance, and if the size of the display area is a second size larger than the first size, the determination unit determines a second range of luminance as the range of display luminance, and a luminance at an upper limit of the second range of luminance is lower than a luminance at an upper limit of the first range of luminance.

Further features of the present disclosure will become apparent from the following description of exemplary embodiments (with reference to the attached drawings).

### BRIEF DESCRIPTION OF THE DRAWINGS

FIG. 1 is a first apparatus configuration diagram illustrating the configuration of a display apparatus according to one or more aspects of the present disclosure.

FIG. 2 is a first block diagram illustrating each function block of the display apparatus according to one or more aspects of the present disclosure.

FIG. 3 is a table illustrating area-luminance information indicating the relationship between a display area size Sr and an upper luminance limit BLM.

FIGS. 4A and 4B are schematic diagrams illustrating images displayed on a display unit.

FIGS. 5A to 5C are schematic diagrams illustrating modes that can be taken by a scaler image and a luminance image.

FIG. 6 is a flowchart illustrating the flow of display control of the display apparatus according to one or more aspects of the present disclosure.

FIG. 7 is a flowchart illustrating the flow of a display luminance setting process according to one or more aspects of the present disclosure.

FIG. 8 a second apparatus configuration diagram of a display apparatus according to one or more aspects of the present disclosure.

FIG. 9 is a second block diagram illustrating each function block of the display apparatus according to one or more aspects of the present disclosure.

FIG. 10 is a table illustrating area-illuminance-luminance information indicating the relationship between a display area size Sr, illuminance Br, and an Upper luminance limit BLM according to one or more aspects of the present disclosure.

FIG. 11 is a flowchart illustrating the flow of display control of the display apparatus according to one or more aspects of the present disclosure.

FIG. 12 is a flowchart illustrating the flow of a display luminance setting process according to one or more aspects of the present disclosure.

FIG. 13 is a third apparatus configuration diagram of a display apparatus according to one or more aspects of the present disclosure.

FIG. 14 is a third block diagram illustrating each function block of the display apparatus according to one or more aspects of the present disclosure.

FIG. 15 is a table illustrating area-distance-luminance information indicating the relationship between a display area size Sr, a distance L, and an upper luminance limit BLM according to one or more aspects of the present disclosure.

FIG. 16 is a flowchart illustrating the flow of display control of the display apparatus according to one or more aspects of the present disclosure.

FIG. 17 is a flowchart illustrating the flow of a display luminance setting process according to one or more aspects of the present disclosure.

FIG. 18 is a fourth block diagram illustrating each function block of a display apparatus according to one or more aspects of the present disclosure.

FIG. 19 is a table illustrating information where the upper luminance limit BLM is associated with the display area size Sr.

### DESCRIPTION OF THE EMBODIMENTS

Embodiments of the present disclosure are described hereinafter with reference to the drawings. The technical scope of the present disclosure is determined by the scope of claims, and is not limited by embodiments illustrated by example below. Moreover, the present disclosure does not necessarily require all combinations of features described in the embodiments. The contents described the specification and drawings are examples, and are not intended to restrict the present disclosure. Various modifications (including organic combinations of the embodiments) can be based on the gist of the present disclosure. These modifications are not excluded from the scope of the present disclosure. In other words, the present disclosure also includes all configurations where the embodiments and their modifications are combined.

### First Embodiment

A display apparatus according to one or more aspects of the present disclosure is described below.

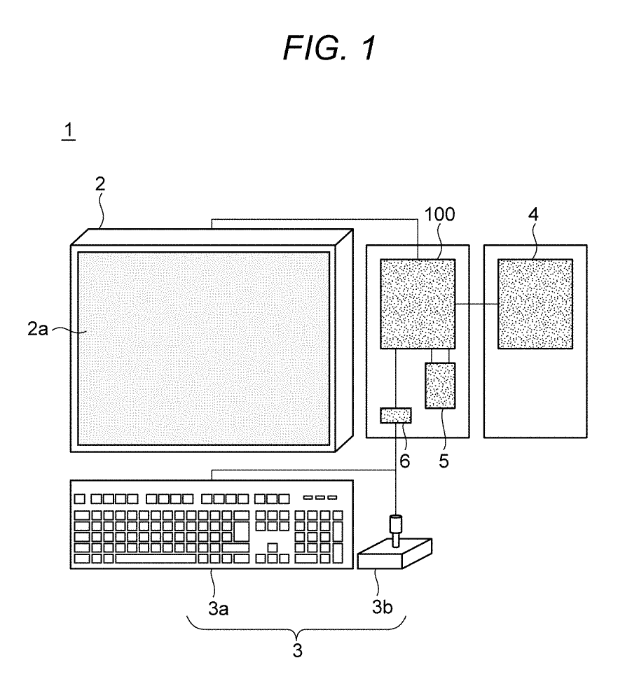

FIG. 1 an apparatus configuration diagram illustrating the configuration of a display apparatus 1 according to the first embodiment of the present disclosure. The display apparatus 1 includes a display unit 2, an input device 3, a storage 4, a memory 5, an input interface (Inter Face, hereinafter input I/F) 6, and a control board 100.

The display unit 2 is liquid crystal display including a liquid crystal panel and a backlight. The display unit 2 displays an image on a screen 2a under control of the control board 100. The display unit 2 is not limited to the display with the liquid crystal panel. The display unit 2 may be a self-emitting display such as an organic EL (Electro Luminescence) display using an organic EL as an element.

In the first embodiment, the screen 2a of the display unit includes pixels arranged in a matrix of 3840 pixels in a horizontal direction and 2160 pixels in a vertical direction. From this point onward, the number of pixels such as described above is expressed as 3840×2160. Moreover, the length of a diagonal of the screen 2a of the display unit 2 is 40 inches. From this point onward, the size of the screen 2a and a size Sr of a display area, in which an image is displayed, of the screen 2a are indicated by the length of the diagonal.

The input device 3 is a device that inputs a user's instruction into the control board 100 via the input I/F 6. The input device 3 includes a keyboard 3a and a joystick 3b. An input device such as a mouse can also be used for the input device 3. The user can select image data to be displayed on the display unit 2, or instruct a setting value of the display luminance of the display unit 2, by use of the input device 3.

The storage 4 is a storage medium in which image data to be displayed by the display apparatus 1 is stored. The storage 4 is a nonvolatile storage medium such as a hard disk. The storage 4 outputs image data to the control board 100. Image data to be supplied to the control board 100 is not limited to the image data to be output from the storage 4. The display apparatus 1 may be connected to an external apparatus to supply image data from the external apparatus to the control board 100.

The memory 5 is a storage medium in which a program, parameters, and the like that can be executed by the control board 100 and are used to control the display unit 2 are stored. The memory 5 connected to the control board 100 to allow the control board 100 to read the stored program and parameters. The memory 5 is a nonvolatile recording medium such as a hard disk.

The input I/F 6 is an interface that inputs the user's instruction input from the input device 3 into the control board 100. The input I/F 6 may convert the instruction input from the input device 3 into a format that can be used by the control board 100 to output it to the control board 100.

The control board 100 is a control board including an arithmetic processing device (processor) that controls the display unit 2 in such a manner as to cause the display unit 2 to display an image, using image data acquired from the storage 4. Moreover, the control board 100 controls the display unit 2 in such a manner as to display an image, using a maximum luminance set by the user. The maximum luminance is a maximum luminance value that can be displayed on the screen 2a. For example, the maximum luminance is the luminance of light that is emitted from the screen 2a when a totally white image is displayed.

The control board 100 determines a setting range of the maximum luminance that can be set on the display unit 2, using the size Sr of the display area, in which an image is displayed, of the screen 2a. Specifically, the control board 100 determines the setting range of the maximum luminance such that an upper limit of the maximum luminance that can be set on the display unit 2 is smaller if the display area size Sr is larger than a predetermined size than if the display area size Sr is equal to or less than the predetermined size.

The control board 100 uses the program and parameters read out from the memory 5, exerts functions described below, and controls the display unit 2. Moreover, part or all of the functions to be exerted by the control board 100 can also be executed by hardware such as an electronic circuit.

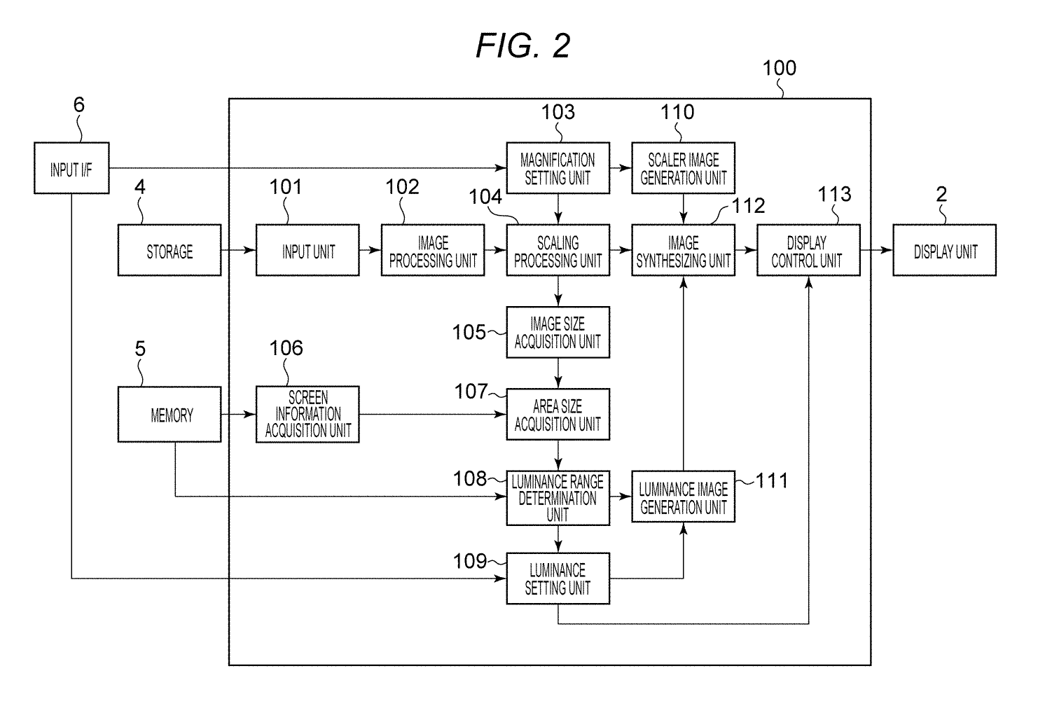

FIG. 2 is a block diagram illustrating each function block of the display apparatus 1. The control board 100 includes an input unit 101, an image processing unit 102, a magnification setting unit 103, a scaling processing unit 104, an image size acquisition unit 105, a screen information acquisition unit 106, an area size acquisition unit 107, a luminance range determination unit 108, a luminance setting unit a scaler image generation unit 110, a luminance image generation unit 111, an image synthesizing unit 112, and a display control unit 113.

The input unit 101 is an interface that acquires input image data input from the storage 4. The input unit 101 outputs the acquired input image data to the image processing unit 102. The input unit 101 may convert the input image data into a format that can be operated by another function block, and output it. In the first embodiment, the input image data is image data with 960×540 pixels.

The image processing unit 102 performs predetermined image processing on the input image data to generate corrected image data. The predetermined image processing can be freely set as, for example, a grayscale conversion process such as gamma conversion by the user or the specifications of the product. The image processing unit 102 outputs the corrected image data to the scaling processing unit 104.

At the instruction acquired from the input I/F 6, the magnification setting unit 103 sets a magnification at which the scaling processing unit 104 enlarges or reduces the corrected image data. The magnification is a magnification ratio at which the scaling processing unit 104 enlarges the corrected image data. The magnification ratio is expressed as 0.1, 0.5, 1.0, 2.0, 4.0, and the like. The magnification setting unit 103 outputs the set magnification to the scaling processing unit 104. Moreover, the magnification setting unit 103 may set magnifications respectively for the horizontal direction and the vertical direction of an image.

The user may set the magnification as the display scale of the display size of an image with respect to the screen 2a. The display scale is the ratio of the display area in which an image is displayed to the screen 2a, and is expressed as 1/1 (life-sized), 1/2, 1/4, and the like with reference to the size of the screen 2a. If the user specifies the display scale, the magnification setting unit 103 uses the number of pixels of the screen 2a and the number of pixels of the corrected image data, calculates the magnification ratio of the corrected image data, and outputs it to the scaling processing unit 104.

The scaling processing unit 104 performs enlargement processing on the corrected image data at the magnification, and generates enlarged image data. In a case that the magnification is less than 1, the scaling processing unit 104 reduces the corrected image data by the enlargement processing at the magnification. The scaling processing unit 104 outputs the enlarged image data to the image synthesizing unit 112 and the image size acquisition unit 105.

The image size acquisition unit 105 acquires the size of the enlarged image data. Specifically, the image size acquisition unit 105 acquires the number of pixels in the horizontal direction and the number of pixels in the vertical direction of the enlarged image data. The image size acquisition, unit 105 outputs the numbers of pixels in the horizontal and vertical directions of the enlarged image data to the area size acquisition unit 107. The image size acquisition unit 105 may acquire the number of pixels in one of the horizontal and vertical directions and the aspect ratio of the image data.

The screen information acquisition unit 106 acquires the size of the screen 2a and the number of pixels of the screen 2a from the memory 5 and outputs them to the area size acquisition unit 107. In the first embodiment, the screen information acquisition unit 106 acquires 40 inches as the size of the screen 2a, and acquires 3840×2160 as the number of pixels of the screen 2a.

The area size acquisition unit 107 uses the number of pixels of the enlarged image data, the size of the screen 2a, and the number of pixels of the screen 2a to acquire the size Sr of the display area, in which an image is displayed, of the screen 2a. Specifically, the area size acquisition unit 107 divides the number of pixels of the enlarged image data by the number of pixels of the screen 2a, and further multiplies the result by the size of the screen 2a, and accordingly calculates and acquires the display area size Sr. The area size acquisition unit 107 outputs the display area size Sr to the luminance range determination unit 108.

The luminance range determination unit 108 determines the setting range of the maximum luminance that can be set on the display unit 2, using the acquired display area size Sr. Specifically, the luminance range determination unit 108 determines an upper luminance limit BLM of the maximum luminance that can set on the display unit 2 (the upper luminance limit), using the acquired display area size Sr. The luminance range determination unit 108 acquires, from the memory 5, area-luminance information indicating the relationship between the display area size Sr and the upper luminance limit BLM, and determines the upper luminance limit BLM, using the area-luminance information and the display area size Sr. The luminance range determination unit 108 outputs the determined range of display luminance to the luminance setting unit 109 and the luminance image generation unit 111.

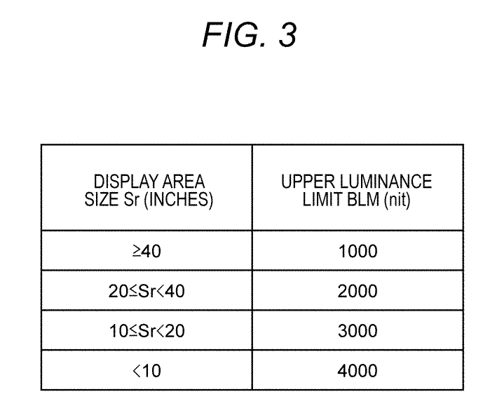

FIG. 3 a table illustrating the area-luminance information indicating the relationship between the display area size Sr and the upper luminance limit BLM. In the first embodiment, the upper luminance limit BLM for a display area size Sr of less than 10 inches is associated with 4000 nit. The upper luminance limit BLM for a display area size Sr of equal to or more than 10 inches and less than 20 inches is associated with 3000 nit. The upper luminance limit BLM for a display area size Sr of equal to or more than 20 inches and less than 40 inches is associated with 2000 nit. The upper luminance limit BLM for a display area size Sr of equal to or more than 40 inches is associated with 1000 nit.

In other words, in the first embodiment, if the display area size Sr is 10 inches, the luminance range determination unit 108 determines the upper luminance limit BLM to be 3000 nit. If the display area size Sr 30 inches that is larger than 10 inches, the luminance range determination unit 108 determines the upper luminance limit BLM to be 2000 nit that is lower than 3000 nit. The relationship between the display area size Sr and the upper luminance limit BLM is not limited to the above-mentioned stepwise relationship. The relationship may be one in which the upper luminance limit BLM decreases with increasing display area size Sr. For example, the luminance range determination unit 108 can also determine the upper luminance limit BLM such that the relationship between the display area size Sr and the upper luminance limit BLM is linear. The relationship between the display area size Sr and the upper luminance limit BLM may be one other than the linear relationship.

At the instruction input from the input I/F 6, the luminance setting unit 109 sets the maximum luminance of the display unit 2 within the acquired range of display luminance. Specifically, the luminance setting unit 109 sets a luminance equal to or less than the upper luminance limit BLM as the maximum luminance in response to the user's input. The luminance setting unit 109 outputs the set maximum luminance to the luminance image generation unit 111 and the display control unit 113.

If the display area size Sr has been changed and the upper luminance limit BLM has been changed in the display apparatus 1, the luminance setting unit 109 changes the maximum luminance set on the display unit 2. If the maximum luminance set before the change of the display area size Sr exceeds the maximum luminance limit BLM due to the change of the display area size Sr, the luminance setting unit 109 sets the post-change upper luminance limit BLM as the maximum luminance. Moreover, if the maximum luminance set before the change of the display area size Sr is equal to or less than the upper luminance limit BLM after the change of the display area size Sr, the luminance setting unit 109 sets the pre-change maximum luminance on the display unit 2.

If the maximum luminance set before the change of the display area size Sr is equal to or less than the upper luminance limit BLM after the change of the display area size Sr, the luminance setting unit 109 may change the set value of the maximum luminance in accordance with the change rate of the pre- and post-change upper luminance limits BLM. Consequently, a change in the total amount of light emission from the screen 2a is suppressed irrespective of the display area size Sr; accordingly, the user can view an image without being aware of a change in brightness.

The scaler image generation unit 110 uses the magnification acquired from the magnification setting unit 103, generates a scaler image being an additional image indicating the magnification to the user, and outputs the scaler image to the image synthesizing unit 112. The scaler image may be a setup user interface image (User Interface, UI) for which the magnification can be set by the user operating a scale or the like displayed in the scaler image with the input I/F 6.

The luminance image generation unit 111 uses the maximum luminance setting range acquired from the luminance range determination unit 108 and the maximum luminance acquired from the luminance setting unit 109, generates a luminance image being an additional image indicating the maximum luminance setting range and the set maximum luminance, and outputs the luminance image to the image synthesizing unit 112. The luminance image may be a setup UI image that can set the set maximum luminance by the user operating a scale or the like displayed in the luminance image with the input I/F 6.

The image synthesizing unit 112 synthetizes the enlarged image data, the scaler image, and the luminance image, generates display image data, and outputs the display image data to the display control unit 113.

The display control unit 113 controls the display unit 2 in such a manner as to display an image with the display image data, using the set maximum luminance. Specifically, the display control unit 113 sets the luminance of the backlight of the display unit 2, using the set maximum luminance. Furthermore, the display control unit 113 controls the transmittance of a liquid crystal element of the liquid crystal panel, using the display image data.

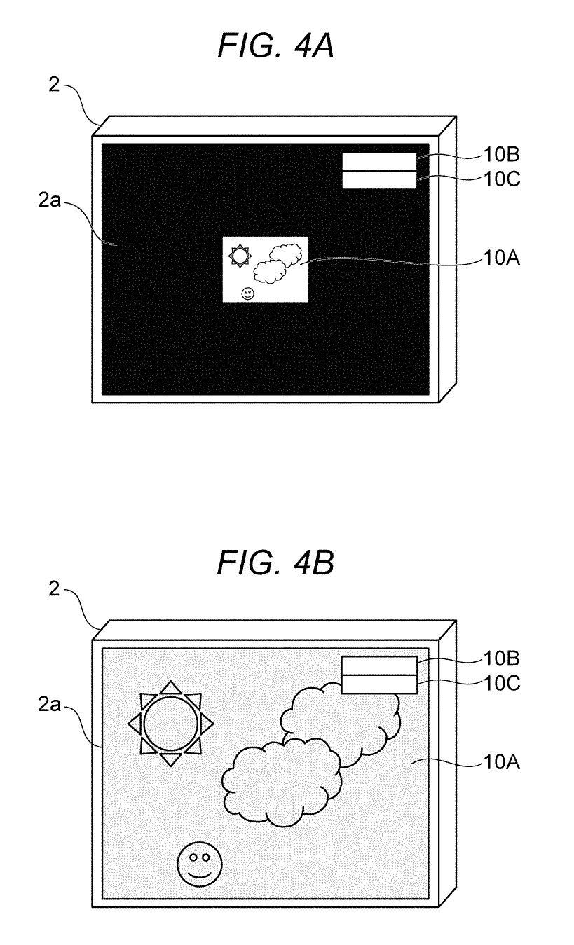

The effects of the display apparatus 1 in the first embodiment are described using FIGS. 4A and 4B. FIGS. 4A and 4B are schematic diagrams illustrating images displayed on the display unit 2.

FIG. 4A is a schematic diagram illustrating images that are displayed on the display unit 2 when the magnification is set to life-size (one time). An image 10A based on the enlarged image data is displayed in the center of the screen 2a. A black image is displayed in the periphery of the screen 2a. Moreover, a scaler image 10B and a luminance image 10C are synthesized and displayed at the top right corner of the screen 2a.

If the magnification is life-sized, the number of pixels of the input image data is 960×540, the number of pixels of the screen 2a is 3840×2160, and the size of the screen 2a is 40 inches. Accordingly, the display area size Sr is 10 inches. Therefore, the luminance range determination unit 108 determines the upper luminance limit BLM to be 3000 nit, using the area-luminance information illustrated in FIG. 3. The luminance setting unit 109 can set the maximum luminance at the upper luminance limit BLM or less. FIG. 4A illustrates a case where the user sets the maximum luminance at 3000 nit and displays the images.

FIG. 4B is a schematic diagram illustrating images that are displayed on the display unit 2 when the magnification is set at four times. If the magnification is four times, the number of pixels of the enlarged image data is 3840×2160 to be equal to the screen 2a. Therefore, the display area size Sr is 40 inches. The luminance range determination unit 108 determines the upper luminance limit BLM to be 1000 nit, using the area-luminance information illustrated in FIG. 3. The luminance setting unit 109 sets the maximum luminance at the upper luminance limit BLM or less. FIG. 4B illustrates a case where the user sets the maximum luminance at 1000 nit and displays the images.

In the display apparatus 1 of the first embodiment, the upper luminance limit BLM that can be set on the display unit 2 when the display area size Sr is 10 inches is 3000 nit. The upper luminance limit BLM that can be set on the display unit 2 when the display area size Sr is 40 inches is 1000 nit that is smaller than 3000 nit. In other words, the range of luminance that can be set on the display unit 2 when the display area size Sr is 10 inches is larger than the range of luminance that can be set on the display unit 2 when the display area size Sr is 40 inches.

Assuming that while viewing an image at a magnification of life-size as illustrated in FIG. 4A, the user changes the magnification to four times. The control board 100 changes the size of the image displayed on the screen 2a and also changes the upper luminance limit BLM that can be set on the display unit 2. The upper luminance limit BLM is changed to 1000 nit in response to the increase of the display area size Sr. At this point in time, the luminance setting unit 109 of the control board 100 controls the maximum luminance to 1000 nit.

Therefore, if the display area of the display unit 2 is large, the upper limit of the maximum luminance that can be set the display unit 2 decreases. Accordingly, the amount of light emission from the screen is restricted even if the display area size Sr is large. Therefore, even if the screen with a large display area is displayed, it is possible to prevent the user from feeling glare.

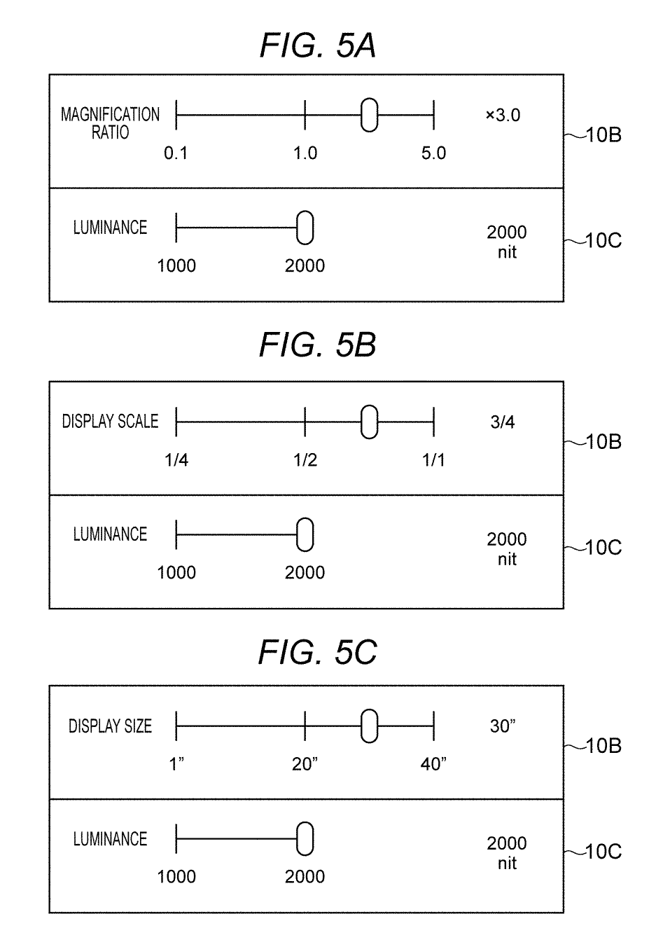

FIGS. 5A to 5C are schematic diagrams illustrating modes that can be taken by the scaler image 10B and the luminance image 100. FIG. 5A is a schematic diagram of the scaler image 10B where the magnification is indicated by the magnification ratio of image data, and the luminance image 100. The scaler image 10B displays the currently set magnification and a magnification settable range with a scale. The user operates a button displayed in the scaler image 10B to enable the change of the magnification. Moreover, the magnification set by the user is displayed in a number on the right of the scale. The scaler image 10B of FIG. 5A illustrates that the magnification is set at 3.0 times.

In the example illustrated in FIG. 5A, the magnification is set at 3.0 times for the number of pixels of the input image data, 960×560. The number of pixels of the screen 2a is 3840×2160, and the size of the screen 2a is 40 inches. Accordingly, the display area size Sr is inches. Therefore, the upper luminance limit BLM is determined to be 2000 nit.

The luminance image 10C displays an adjustable range of the maximum luminance and the maximum luminance set on the display unit 2 with a scale. An upper limit of the scale is the upper luminance limit BTM determined by the luminance range determination unit 108. Therefore, 2000 nit is displayed, as the upper limit of the adjustable range of the maximum luminance to be displayed, in the luminance image 10C.

The user operates a button displayed in the luminance image 10C to enable the change of the set value of the maximum luminance. Moreover, the value of the maximum luminance set by the user is displayed on the right of the scale of the luminance image 10C. In the case of FIG. 5A, it illustrates that the user has set 2000 nit as the maximum luminance.

FIG. 5B is a schematic diagram of the scaler image 10B where the magnification is indicated by the ratio (display scale) of the display area size to the size of the screen 2a, and the luminance image 10C. FIG. 5C is a schematic diagram of the scaler image 10B where the magnification is indicated by the display area size Sr, and the luminance image 10C. Information indicated in the scaler image 10B is simply required to be one that allows the user to find the size of an image displayed on the screen 2a. Moreover, the maximum luminance and the upper luminance limit, which are displayed in the luminance image 10C, are not limited to the unit nit as illustrated in FIGS. 5A to 5C, and may be expressed in units of cd/m2 or the like.

According to the first embodiment, a range of the maximum luminance that can be set on the display unit 2, the range being determined when the display area size Sr is a predetermined size, is smaller than a range of the maximum luminance that can be set on the display unit 2, the range being determined when the display area size Sr is smaller than the predetermined size. Therefore, when the size of an image displayed on the screen 2a is large, it is possible to suppress the increase of luminance set by the user on the display unit 2. Therefore, when the size of the image displayed on the screen is increased, the increase of glare that the user feels can be suppressed.

The above-mentioned function to be exerted by each function block of the control board 100 can also be achieved by the processor included in the control board 100 executing a processing step equivalent to the function of the function block with the program read out from the memory 5.

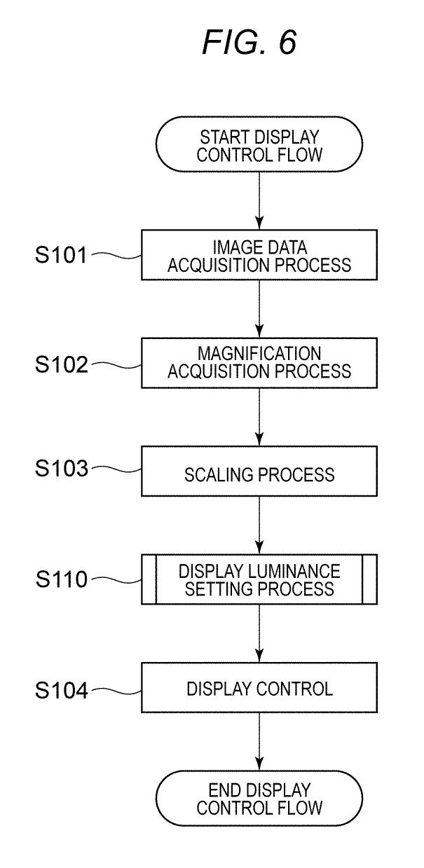

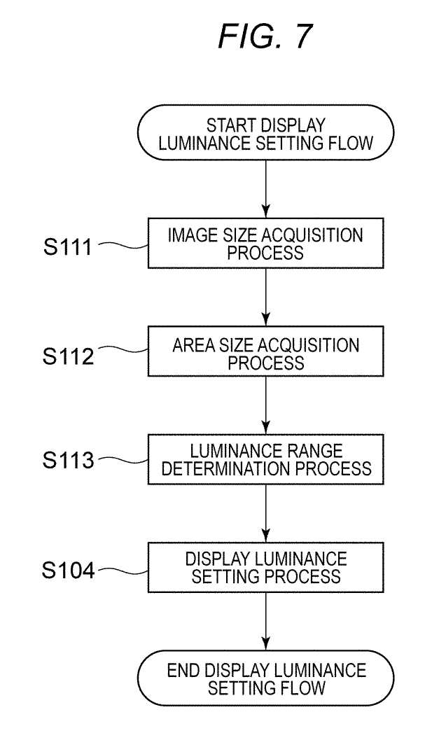

FIG. 6 is a flowchart illustrating the flow of display control of the display apparatus in the first embodiment. Moreover, FIG. 7 is a flowchart illustrating the flow of a display luminance setting process in the first embodiment.

S101 is the step of executing the process of acquiring image data. The image data may be image data acquired from the storage 4, or image data acquired from the storage 4 on which predetermined image processing has been performed.

S102 is the step of executing the process of acquiring, from the input I/F 6, a magnification specified by the user. S103 is the step of executing the process of performing enlargement processing on the image data acquired in S101 with the image data and the magnification acquired in S102 to generate enlarged image data.

S110 is the step of executing the process of setting the display luminance of the display unit 2 with the image data acquired in S101 and the magnification acquired in S102. FIG. 7 is a flowchart illustrating the subflow of the display luminance setting process of S110.

S111 is the step of executing the process of acquiring the image size of the image data acquired in S101. S112 is the step of executing the process of acquiring the display area size Sr (area size) of the screen 2a with the image size acquired in S111, and the number of pixels and size of the screen 2a of the display unit 2 acquired from the memory 5.

S113 is the step of executing the process of determining the range of luminance that can be set on the display unit 2 with the display area size Sr acquired in S112. In S113 as in the process of the luminance range determination unit 108, the range of luminance is determined such that the upper limit of a settable range of luminance decreases with increasing display area size Sr.

S114 is the step of executing the process of setting the display luminance of the display unit 2 with the luminance set value input from the input I/F 6 within the range of luminance determined in S113. With S114, the subflow of the display luminance setting process ends. The processing proceeds to S104.

S104 is the step of controlling the display unit 2 in such a manner as to display an image on the screen 2a of the display unit 2 at the display luminance set in S110, using the enlarged image data generated in S103.

The steps of S103 and S110 may be executed in parallel after S102,

### Second Embodiment

A display apparatus according to one or more aspects of the present disclosure is described below.

If the ambient brightness of the display apparatus is low, a user may feel glare even from an image displayed at a low luminance level. A display apparatus 1 according to the second embodiment controls a range of luminance that can be set on the display apparatus 1, according to a size Sr of a display area, in which an image is displayed, of a screen 2a, and the ambient brightness (illuminance) of the display apparatus 1 to suitably control the visibility of the display apparatus 1.

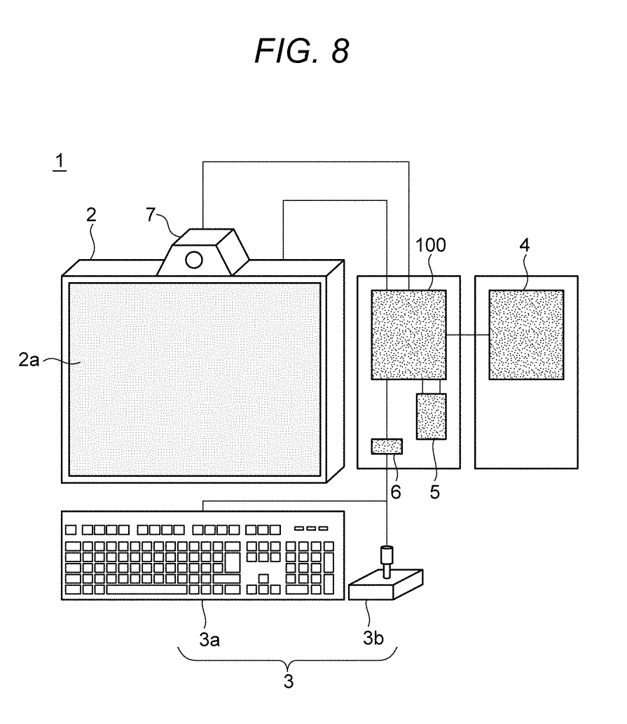

FIG. 8 is an apparatus configuration diagram of the display apparatus 1 according to the second embodiment. The display apparatus 1 according to the second embodiment includes a display unit 2, an input device, a storage 4, a memory 5, an input I/F 6, an illuminance sensor 7, and a control board 100. The members to which the same reference numerals as those of the display apparatus 1 according to the first embodiment are assigned exert the same functions. Accordingly, the descriptions are omitted.

The illuminance sensor 7 is an illuminance detection apparatus that detects ambient brightness (illuminance) Br of the display apparatus 1. The illuminance sensor 7 outputs the detected illuminance Br to the control board 100.

The control board 100 is a control board that controls the display unit 2 in such a manner as to display an image on the display unit 2 using input image data acquired from the storage 4. Moreover, the control board 100 controls the display unit 2 in such a manner as to display an image, using the maximum luminance set by a user. The control board 100 determines a range of the maximum luminance that can be set on the display unit 2, using the illuminance Br and the size Sr of the display area, in which an image is displayed, the screen 2a. Specifically, the control board 100 determines the range of the maximum luminance such that an upper luminance limit BLM of the maximum luminance that can be set on the display unit 2 (the upper luminance limit) decreases with increasing display area size Sr, and furthermore the upper luminance limit BLM increases with increasing illuminance Br.

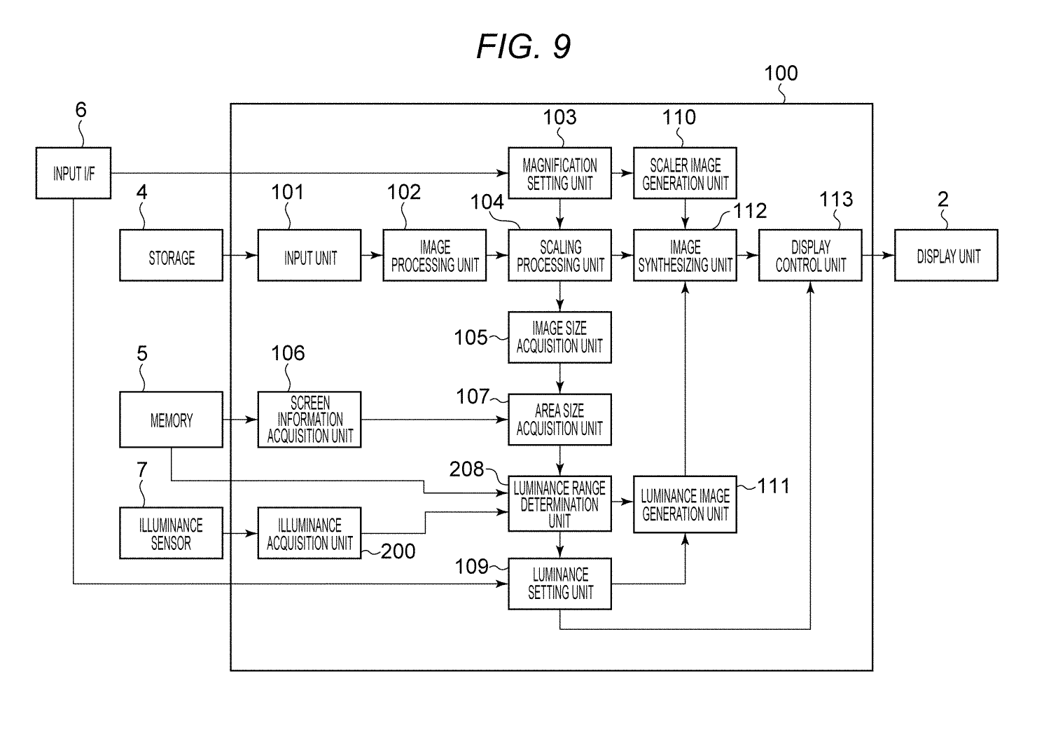

FIG. 9 is a block diagram illustrating each function block of the display apparatus 1 in the second embodiment. The control board 100 includes an illuminance acquisition unit 200 in addition to similar function blocks to those of the first embodiment. The function blocks to which the same names and reference numerals as those of the first embodiment are assigned exert similar functions to those of the first embodiment. Accordingly, the descriptions are omitted.

The illuminance acquisition unit 200 acquires the ambient illuminance Br of the display apparatus 1 from the illuminance sensor 7. The illuminance acquisition unit 200 outputs the acquired illuminance Br to a luminance range determination unit 208.

The luminance range determination unit 208 determines the upper limit of the maximum luminance that can be set on the display unit (the upper luminance limit), using the display area size Sr acquired from the area size acquisition unit 107 and the illuminance Br acquired from the illuminance acquisition unit 200. The luminance range determination unit 208 acquires, from the memory 5, area-illuminance-luminance information indicating the relationship between the display area size Sr, the illuminance Br, and the upper luminance limit BLM.

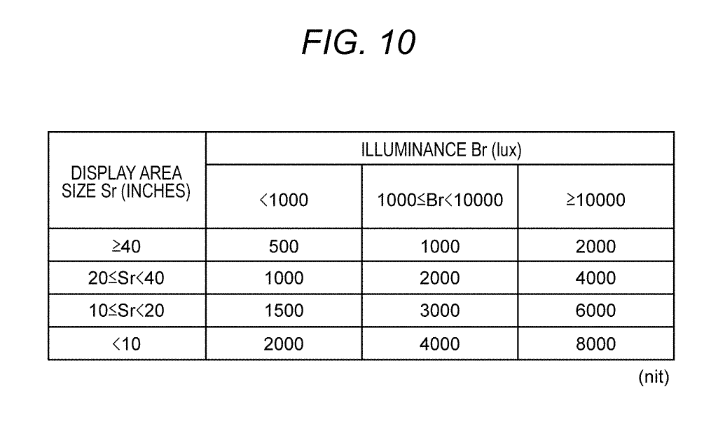

FIG. 10 is a table illustrating the area-illuminance-luminance information indicating the relationship between the display area size Sr, the illuminance Br, and the upper luminance limit BLM in the second embodiment. In the second embodiment, if the illuminance Br is equal to or more than 1000 lux and less than 10000 lux, the ambient brightness of the display apparatus 1 is assumed to be a range of the specific brightness. If the illuminance Br is less than 1000 lux, in other words, if the ambient brightness of the display apparatus 1 is lower than the range of the specific brightness, the upper luminance limit BLM is associated with the display area size Sr in such a manner as to be lower than one at the range of the specific brightness.

Moreover, if the illuminance Br is equal to or more than 10000 lux, in other words, if the ambient brightness of the display apparatus 1 is higher than the range of the specific brightness, the upper luminance limit BLM is associated with the display area size Sr in such a manner as to be higher than one at the range of the specific brightness.

The relationship between the display area size Sr, the illuminance Br, and the upper luminance limit BLM is not limited to the above-mentioned one. The relationship can be freely set in accordance with the characteristics of the display unit 2.

The luminance range determination unit 208 determines the upper luminance limit BLM, using the area-illuminance-luminance information illustrated in FIG. 10, the acquired display area size Sr, and the acquired illuminance Br, and outputs the upper luminance limit BLM to the luminance setting unit 109.

According to the display apparatus 1 of the second embodiment, the range of luminance that can be set on the display unit 2 is determined in accordance with the size Sr of the display area, which an image is displayed, of the screen 2a, and the ambient brightness (illuminance Br) of the display apparatus 1. Therefore, when the size of an image displayed on the screen 2a is large, it is possible to suppress the increase of the luminance set by the user on the display unit 2. Therefore, when the size of the image displayed on the screen is increased, the increase of glare that the user feels can be suppressed. Furthermore, the range of luminance that can be set on the display unit 2 is determined in accordance with the ambient brightness of the display apparatus 1; accordingly, it is possible to prevent the user from feeling glare resulting from the change of the ambient brightness of the display apparatus 1.

In the second embodiment, the upper luminance limit BLM is determined based on the display area size Sr and the illuminance Br. However, it is also possible to correct the upper luminance limit BLM determined based on the display area size Sr, using the illuminance Br, and determine the upper luminance limit BLM.

The above-mentioned function to be exerted by each function block of the control board 100 can also be achieved by the processor included in the control board 100 executing a processing step equivalent to the function of the function block with the program read out from the memory 5.

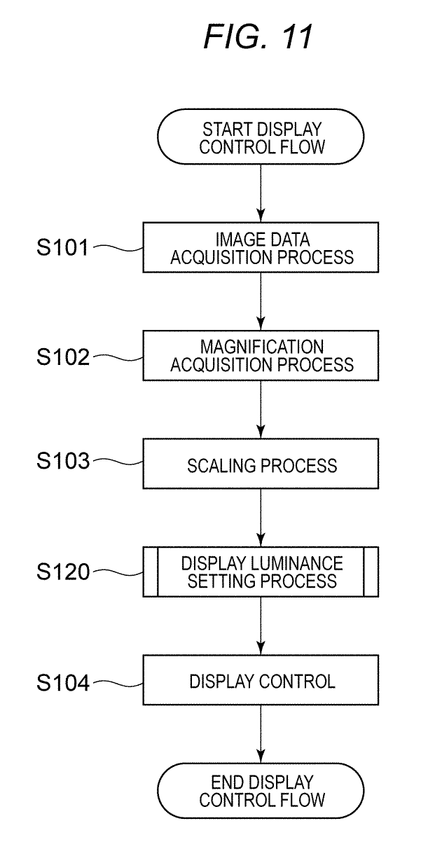

FIG. 11 is a flowchart illustrating the flow of display control of the display apparatus in the second embodiment. Steps of S101 to S104 execute similar processes to the steps to which the same reference numerals as those of the first embodiment are assigned. Accordingly, the descriptions are omitted.

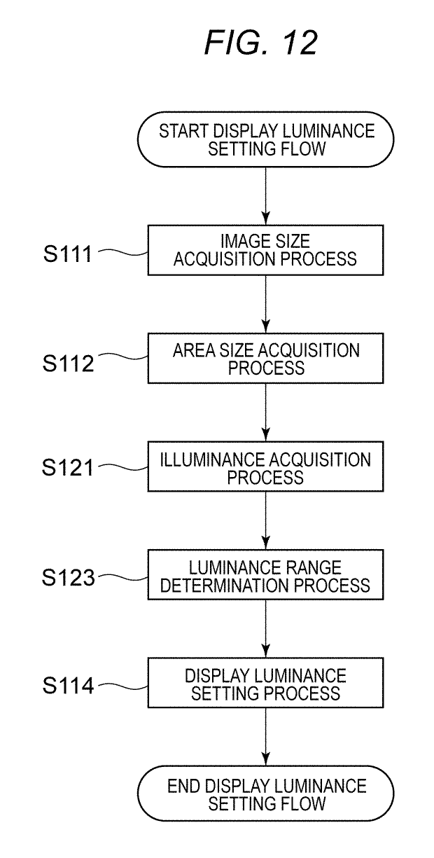

S120 is the step of executing the process of setting the display luminance of the display unit 2 using the image data acquired in S101, the magnification acquired in S102, and the ambient brightness (illuminance Br) of the display unit 2. FIG. 12 is a flowchart illustrating the subflow of the display luminance setting process of S120. Steps of S11, S112, and S114 execute similar processes to the steps to which the same reference numerals as those of the first embodiment are assigned. Accordingly, the descriptions are omitted.

S121 is the processing step of executing the process of acquiring the illuminance Br detected by the illuminance sensor 7. S123 is the step of executing the process of determining the range of luminance that can be set on the display unit 2, using the display area size Sr acquired in S112 and the illuminance Br acquired in S121. In S123, as in the process of the luminance range determination unit 208, the range of luminance is determined such that the upper limit of the settable range of luminance decreases with increasing display area size Sr, and the upper limit of the settable range of luminance increases with increasing illuminance Br.

### Third Embodiment

A display apparatus according to one or more aspects of the present disclosure is described below.

When the distance between a screen of the display apparatus and a user who views the screen is short, the user may feel glare even from an image displayed at a low luminance level. A display apparatus 1 according to the third embodiment controls a range of luminance that can be set on the display apparatus 1 in accordance with a size Sr our a display area, in which an image is displayed, of a screen 2a, and a distance L between the screen 2a of the display apparatus 1 and the user, and suitably controls the visibility of the display apparatus 1.

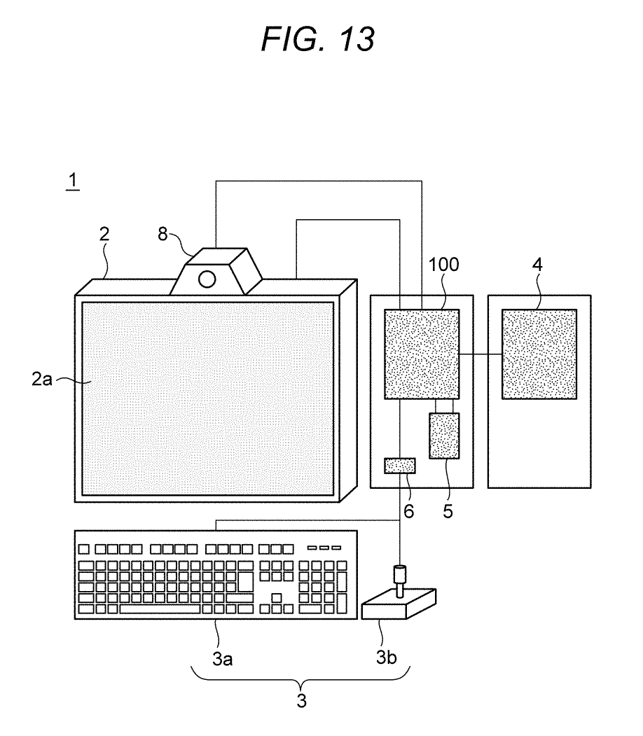

FIG. 13 is an apparatus configuration diagram of the display apparatus 1 according to the third embodiment. The display apparatus 1 according to the third embodiment includes a display unit 2, an input device 3, a storage 4, a memory 5, an input I/F 6, a distance measurement sensor 8, and a control board 100. The members to which the same reference numerals as those of the display apparatus according to the first embodiment are assigned exert the same functions. Therefore, the descriptions are omitted.

The distance measurement sensor 8 is a sensor that measures the distance L between the screen 2a and the user who viewing the screen 2a. The distance measurement sensor 8 outputs the measured distance L to the control board 100.

The control board 100 is a control board that controls the display unit 2 in such a manner as to display an image on the display unit 2, using image data acquired from the storage 4. Moreover, the control board 100 controls the display unit 2 in such a manner as to display an image, using a maximum luminance set by the user. The control board 100 determines a range of the maximum luminance that can be set on the display unit 2, using the distance L acquired from the distance measurement sensor 8, and the size Sr of the display area, in which an image is displayed, of the screen 2a. Specifically, the control board 100 determines the range of the maximum luminance such that an upper luminance limit BLM of the maximum luminance that can be set on the display unit 2 (the upper luminance limit) decreases with increasing display area size Sr, and furthermore the upper luminance limit BLM decreases with decreasing distance L.

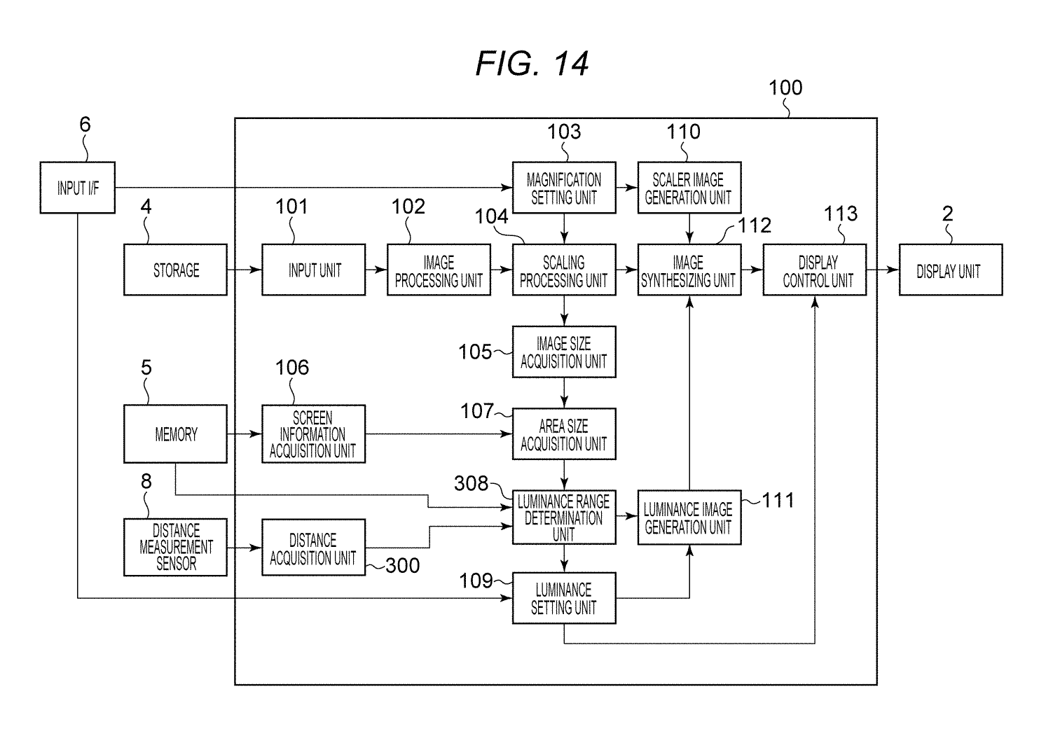

FIG. 14 is a block diagram illustrating each function block of the display apparatus 1 in the third embodiment. The control board 100 includes a distance acquisition unit 300 in addition to similar function blocks to those of the first embodiment. The function blocks to which the same names and reference numerals as those of the first embodiment are assigned exert similar functions to those of the first embodiment. Accordingly, the descriptions are omitted.

The distance acquisition unit 300 acquires, from the distance measurement sensor 8, the distance L to be used by a luminance range determination unit 308 to determine the upper luminance limit, and outputs the distance L to the luminance range determination unit 308. If there is a plurality of users, the distance acquisition unit 300 outputs the distance L to the luminance range determination unit 308, taking the distance between the user who is closest to the screen 2a and the screen 2a as the distance L. If there is a plurality of users, the distance acquisition unit 300 can also output the distance L to the luminance range determination unit 308, taking an average position of the distances between the plurality of users and the screen 2a as the distance L.

The luminance range determination unit 308 determines the upper luminance limit BLM such that the upper luminance limit BLM decreases with increasing display area size Sr, and the upper luminance limit BLM decreases with decreasing distance L. The luminance range determination unit 308 determines the upper luminance limit BLM using the display area size Sr acquired from the display area size acquisition unit 18, and the distance L acquired from the distance acquisition unit 300. The luminance range determination unit 308 acquires, from the memory 5, area-distance-luminance information indicating the relationship between the display area size Sr, the distance L, and the upper luminance limit BLM.

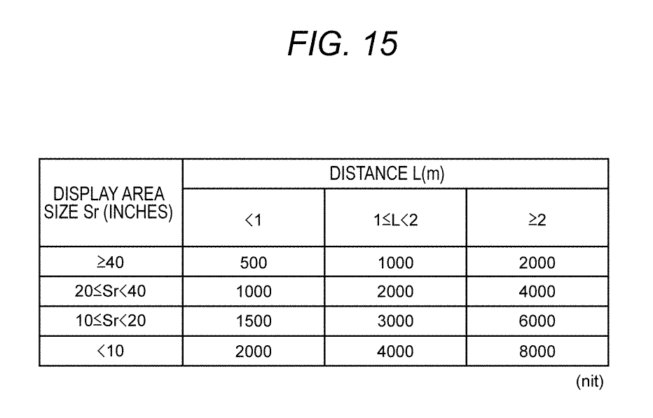

FIG. 15 is a table illustrating the area-distance-luminance information indicating the relationship between the display area size Sr, the distance L, and the upper luminance limit BLM in the third embodiment. If the distance L is equal to or more than one meter and less than two meters in the third embodiment, the distance L to the user is assumed to be in a range of a specific distance. If the distance L is less than one meter, in other words, if the distance L is shorter than the range of the specific distance, the upper luminance limit BLM is associated with the display area size Sr in such a manner as to be lower than one at the range of the specific distance.

Moreover, if the distance L is equal to or more than two meters, in other words, if the distance L is longer than the range of the specific distance, the upper luminance limit BLM is associated with the display area size Sr in such a manner as to be higher than one at the range of the specific distance. The relationship between the display area size Sr, the distance L, and the upper luminance limit BLM is not limited to the above-mentioned one. The relationship can be freely set in accordance with the characteristics of the display unit 2.

The luminance range determination unit 308 sets the upper luminance limit BLM using the area-distance-luminance information, the display area size Sr, and the distance L, and outputs the upper luminance limit BLM to the luminance setting unit 109.

According to the display apparatus 1 of the third embodiment, the range of luminance that can be set on the display unit 2 is determined in accordance with the size Sr of the display area, in which an image is displayed, of the screen 2a, and the distance L between the screen 2a and the user. Therefore, when the size of the image displayed on the screen 2a is large, it is possible to suppress the increase of luminance set by the user on the display unit 2. When the size of the image displayed on the screen increases, it is possible to suppress the increase of glare that the user feels. Furthermore, the range of luminance that can be set on the display unit 2 is determined in accordance with the distance L between the screen 2a and the user; accordingly, it is possible to prevent the user from feeling glare when the distance between the user and the screen 2a is reduced.

In the third embodiment, the upper luminance limit BLM is determined based on the display area size Sr and the distance L. However, it is also possible to correct the upper luminance BLM determined based on the display area size Sr using the distance L and determine the upper luminance limit BLM.

The above-mentioned function to be exerted by each function block of the control board 100 can also be achieved by the processor included in the control board 100 executing a processing step equivalent to the function of the function block with the program read out from the memory 5.

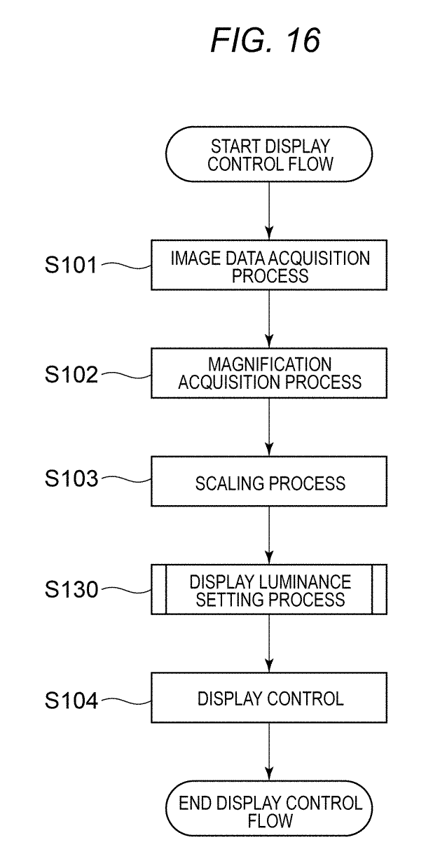

FIG. 16 is a flowchart illustrating the flow of display control of the display apparatus in the third embodiment. Steps of S101 to S104 execute similar processes to the steps to which the same reference numerals as those of the first embodiment are assigned. Accordingly, the descriptions are omitted.

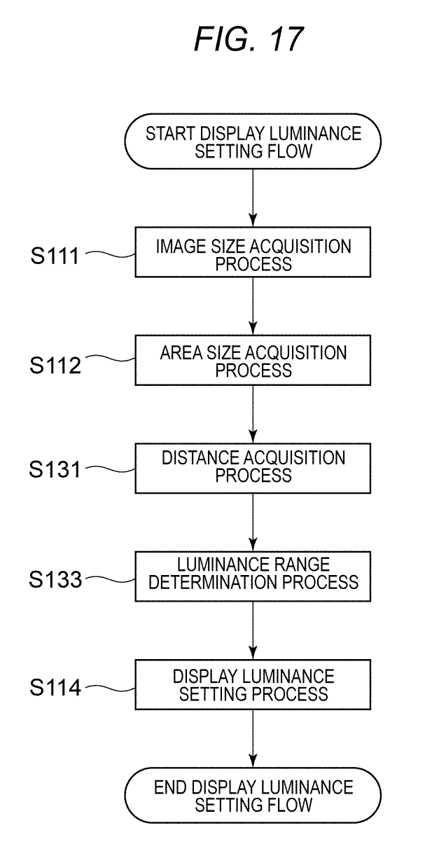

S120 is the step of executing the process of setting the display luminance of the display unit 2, using the image data acquired in S101, the magnification acquired in S102, and the distance L between the user and the display unit 2. FIG. 17 is a flowchart illustrating the subflow of the display luminance setting process of S120. Steps of S111, S112, and S114 execute similar processes to the steps to which the same reference numerals as those of the first embodiment are assigned. Accordingly, the descriptions are omitted.

S131 is the processing step of executing the process of acquiring the distance L detected by the distance measurement sensor 8. S133 is the step of executing the process of determining the range of luminance that can be set on the display unit 2, using the display area size Sr acquired in S112 and the distance L acquired in S131. In S133, as in the process of the luminance range determination unit 308, the range of luminance is determined such that the upper limit of the settable range of luminance decreases with increasing display area size Sr, and the upper limit of the settable range of luminance increases with increasing distance L.

### Fourth Embodiment

A display apparatus according to one or more aspects of the present disclosure is described below.

In the first to third embodiments, the upper luminance limit BLM is determined based on the display area size Sr. The display apparatus according to the fourth embodiment determines the display area size Sr using the determined upper luminance limit BLM. Consequently, a user can view an image of a suitable display area size Sr at luminance desired for a view.

An apparatus configuration of a display apparatus of the fourth embodiment is similar to that of the display apparatus of the first embodiment. Accordingly, the description is omitted.

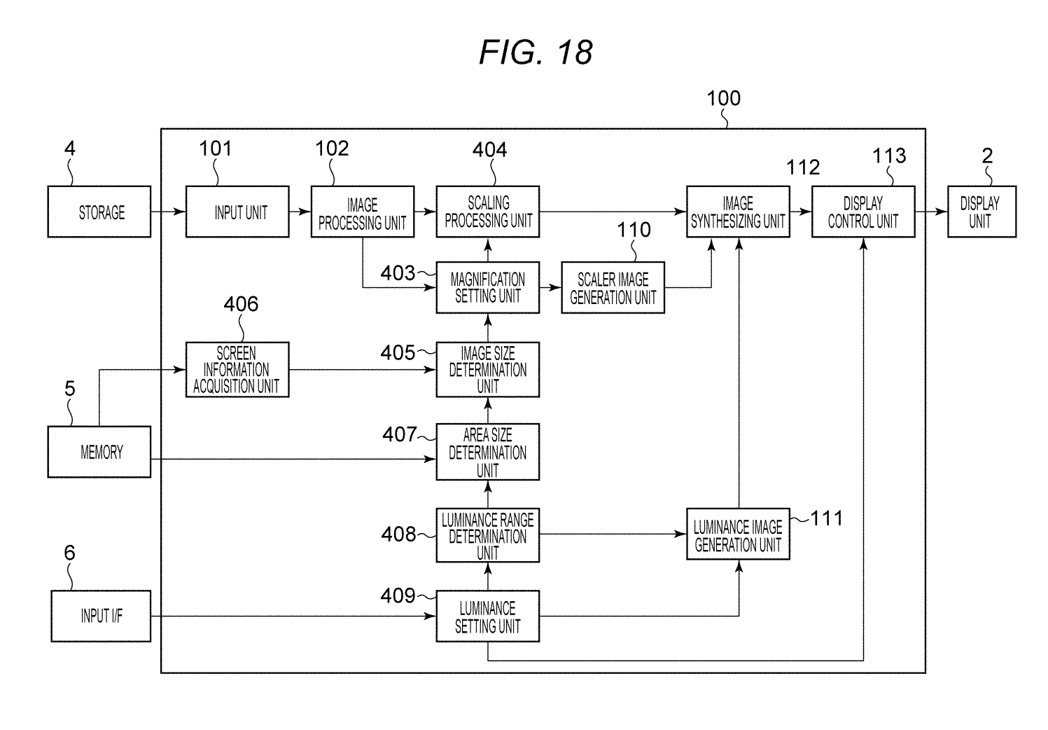

FIG. 18 is a block diagram illustrating each function block of the display apparatus 1 of the fourth embodiment. A control board 100 includes an input unit 101, an image processing unit 102, a magnification setting unit 403, scaling processing unit 404, an image size determination unit 405, a screen information acquisition unit 406, an area size determination unit 407, a luminance range determination unit 408, a luminance setting unit 409, a scaler image generation unit 110, a luminance image generation unit 111, an image synthesizing unit 112, and a display control unit 113. The function blocks to which the same names and reference numerals to those of the function blocks of the control board 100 of the first embodiment are assigned exert similar functions to those of the first embodiment. Accordingly, the descriptions are omitted.

The luminance setting unit 409 sets the maximum luminance for display on the display unit 2 at the instruction of the input I/F 6. The luminance setting unit. 409 determines whether or not the maximum luminance to be set exceeds the upper luminance limit BLM. If the maximum luminance does not exceed the upper luminance limit BLM, the luminance setting unit 409 outputs the maximum luminance to the display control unit 113. If the maximum luminance exceeds the upper luminance limit BLM, the luminance setting unit 409 outputs the maximum luminance to be set and an upper luminance limit BLM change instruction to the luminance range determination unit 408.

The luminance range determination unit 408 determines the acquired maximum luminance to be the upper luminance limit BLM when having received the upper luminance limit BLM change instruction from the luminance setting unit 409. The luminance range determination unit 408 outputs the determined upper luminance limit BLM to the area size determination unit 407.

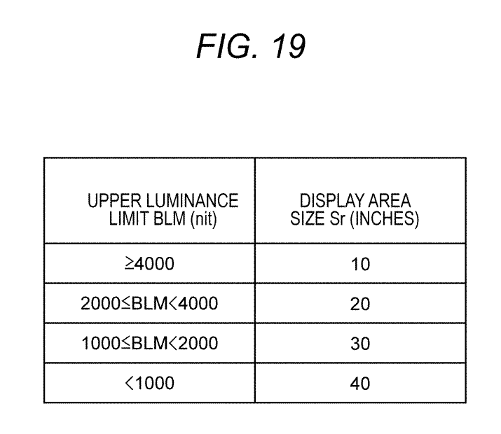

The area size determination unit 407 determines the display area size Sr such that the display area size Sr decreases as the acquired upper luminance limit BLM increases. The area size determination unit 407 determines the display area size Sr, using the acquired upper luminance limit BLM and information in which the upper luminance limit BLM is associated with the display area size Sr, the information having been acquired from the memory 5. FIG. 19 is a table illustrating the information in which the upper luminance limit BLM is associated with the display area size Sr. If the upper luminance limit BLM is equal to or more than 2000 nit and less than 4000 nit, the display area size Sr is associated with 20 inches. Similarly, display area sizes Sr are associated with upper luminance limits BLM. The area size determination unit 407 outputs the determined display area size Sr to the image size determination unit 405.

The image size determination unit 405 determines the size of display image data, using the acquired display area size Sr, and the size and number of pixels of the screen 2a acquired from the screen information acquisition unit 106. Specifically, the image size determination unit 405 determines the number of pixels of enlarged image data to be generated by the scaling processing unit 404.

For example, if the size of the screen 2a is 40 inches, the number of pixels of the screen 2a is 3840×2160, and the display area size Sr determined by the area size determination unit 407 is 20 inches, the image size determination unit 405 sets the size of the display image data to 1920×1080.

The image size determination unit 405 outputs the determined size of the display image data to the magnification setting unit 403.

The magnification setting unit 403 sets the magnification on the scaling processing unit 404, using the size of the corrected image data acquired from the image processing unit 102 and the acquired size of the display image data. Specifically, the magnification setting unit 403 sets the magnification using the number of pixels of the corrected image data and the number of pixels of image data for display. If the number of pixels of the corrected image data is 960×540 and the number of pixels of the image data for display is 1920×1080, the magnification setting unit 403 sets the magnification at two times.

If the aspect ratio of the image data for display is different from that of the corrected image data, the magnification setting unit 403 sets the magnification using the number of pixels of the corrected image data in a horizontal or vertical direction in which the number of pixels is smaller, and the number of pixels of the image data for display in the same direction. Consequently, the size of the enlarged image data to be generated by the scaling processing unit 404 does not exceed the size of the image data for display. If the aspect ratio of the image data for display is different from that of the corrected image data, in addition to the setting of the magnification as described above, the aspect ratio of the image data for display may be determined in accordance with the aspect ratio of the corrected image data and set on the scaling processing unit 404.

The scaling processing unit 404 uses the acquired magnification to enlarge the corrected image data acquired from the image processing unit 102 and generate enlarged image data.

According to the display apparatus described in the fourth embodiment, the display area size Sr is changed according to the maximum luminance specified by the use accordingly, it is possible to prevent the user who is viewing the image displayed on the display apparatus 1 from feeling glare.

As in the first to third embodiments, the above-mentioned function to be exerted by each function block of the control board 100 can also be achieved by the processor included in the control board 100 executing the program read from the memory 5.

### Other Embodiments

The first to fourth embodiments illustrate the case where the display unit 2 displays one screen. However, the display method is not limited to this. If a plurality of sets of image data is displayed by picture-in-picture (PiP), the present disclosure can be applied in this case, the size of a window displayed on the display unit 2 is set as one display area, the upper luminance limit BLM for the display area is associated with the display area size Sr to perform control; accordingly, glare can be prevented.

The present disclosure can be embodied even if the display unit 2 is a projector that projects an image onto a screen to display the image thereon. In this case, the screen 2a indicates an area where the projector can display the image on the screen. The screen information acquisition unit 106 can acquire the size of the screen 2a from information such as the distance between the projector and the screen and the projection angle of the projector.

The present disclosure may be a method for controlling a display apparatus by executing the processing steps corresponding to the function blocks of the control board 100 described in the first to fourth embodiments this case, the arithmetic processing device included in the control board 100 executes the processing steps with the program read out from the memory 5; accordingly, the effects described in the present disclosure can be obtained.

In the first to fourth embodiments, the display apparatus 1 including the control board 100 and the display unit 2 is described. However, the present disclosure may be an image processing apparatus that outputs an image and the range of luminance to the display unit 2.

In this case, an image processing apparatus 10 is a processing apparatus that is connected to the display unit 2 to control the display unit 2. The image processing apparatus 10 exerts similar functions to those of the control board 100 to output image data to be displayed on the display unit 2, and acquires the resolution and size of the screen 2a of the display unit 2 to output the range of luminance that can be set on the display unit 2, using the display area size Sr. The display unit 2 sets the maximum luminance within the acquired range of luminance, using the acquired image data, and displays an image on the screen 2a.

Consequently, the range of brightness of an image to be displayed on the display unit 2 can be suitably controlled in accordance with the display area size Sr of the display unit 2.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s)) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2016-023060, filed Feb. 9, 2016, which is hereby incorporated by reference herein in its entirety.

What is claimed is:

1. A display apparatus comprising:
a display unit configured to display an image on a screen, using an input image;
a first acquisition unit configured to acquire a size of a display area, in which the image is displayed, of the screen;
a determination unit configured to determine a settable range of display luminance, using the size of the display area;
a setting unit configured to set display luminance of the image to he displayed on the screen, within the range of display luminance determined by the determination unit; and
a control unit configured to control the display unit in such a manner as to display the image at the set display luminance,
wherein upon the size of the display area being a first size, the determination unit determines a first range of luminance as the range of display luminance, and upon the size of the display area being a second size larger than the first size, the determination unit determines a second range of luminance as the range of display luminance, and a luminance at an upper limit of the second range of luminance is lower than a luminance at an upper limit of the first range of luminance.

2. The display apparatus according to claim 1, further comprising:
a second acquisition unit configured to acquire a size of the screen of the display unit; and
a third acquisition unit configured to acquire a size of the image,
wherein the first acquisition unit acquires the size of the display area, using the size of the screen and the size of the image.

3. The display apparatus according to claim 1, further comprising:
a scaling processing unit configured to enlarge the input image and generate the image; and
a magnification setting unit configured to set a magnification at which the scaling processing unit enlarges the input image.

4. The display apparatus according to claim 3, further comprising a first generation unit configured to generate a first additional image indicating the magnification, wherein the control unit controls the display unit in such a manner as to display the first additional image on the screen.

5. The display apparatus according to claim 4, wherein the first additional image is a user interface image used by a user to set the magnification.

6. The display apparatus according to claim 1, further comprising a second generation unit configured to generate a second additional image indicating the range of display luminance determined by the determination unit and the display luminance set by the setting unit, wherein the control unit controls the display unit in such a manner as to display the second additional image on the screen.

7. The display apparatus according to claim 6, wherein the second additional image is a user interface image used by a user to set the display luminance.

8. The display apparatus according to claim 1, further comprising an illuminance acquisition unit configured to acquire ambient brightness of the display apparatus, wherein the determination unit determines the range of display luminance settable by the setting unit, using the brightness acquired by the illuminance acquisition unit and the size of the display area.

9. The display apparatus according to claim 1, further comprising a distance acquisition unit configured to acquire a distance between a user who is viewing the screen of the display apparatus and the screen, wherein the determination unit determines the range of display luminance settable by the setting unit, using the distance acquired by the distance acquisition unit and the size of the display area.

10. A display apparatus comprising:
a display unit configured to display an image on a screen;
a setting unit configured to set display luminance of the image to be displayed on the screen;
an acquisition unit configured to acquire an upper limit of a range of display luminance settable by the setting unit;
a determination unit configured to set a size of a display area, in which the image is displayed, of the screen, using the upper limit of the range of display luminance acquired by the acquisition unit; and
a control unit configured to control the display unit in such a manner as to display the image in the display area set by the setting unit, using the display luminance set by the setting unit,
wherein upon the upper limit of the range of display luminance being a first luminance, the determination unit sets the size of the display area to a first size, and upon the upper limit of the range of display luminance being a second luminance higher than the first luminance, the determination unit sets the size of the display area to a second size smaller than the first size.

11. A method for controlling a display apparatus including a display unit configured to display an image on a screen, the method comprising:
a first acquisition step of acquiring a size of a display area, in which the image is displayed, of the screen;
a determination step of determining a settable range of display luminance, using the size of the display area;
a setting step of setting display luminance of the image to be displayed on the screen, within the range of display luminance determined in the determination step; and
a control step of controlling the display unit in such a manner as to display the image at the set display luminance,
wherein the determination step includes determining a first range of luminance as the range of display luminance upon the size of the display area being a first size, and the determination step includes determining a second range of luminance as the range of display luminance upon the size of the display area being a second size larger than the first size, and a luminance at an upper limit of the second range of luminance is lower than a luminance at an upper limit of the first range of luminance.

12. The method for controlling the display apparatus according to claim 11, further comprising:
a second acquisition step of acquiring a size of the screen of the display unit; and
a third acquisition step of acquiring a size of the image,
wherein the first acquisition step includes acquiring the size of the display area, using the size of the screen and the size of the image.

13. The method for controlling the display apparatus according to claim 11, further comprising:
an enlargement processing step of enlarging an input image and generating the image; and
a magnification setting step of setting a magnification at which the input image is enlarged in the enlargement processing step.

14. The method for controlling the display apparatus according to claim 13, further comprising a first generation step of generating a first additional image indicating the magnification, wherein the control step includes controlling the display unit in such a manner as to display the first additional image on the screen.

15. The method for controlling the display apparatus according to claim 11, further comprising a second generation step of generating a second additional image indicating the range of display luminance determined in the determination step and the display luminance set in the setting step, wherein the control step includes controlling the display unit in such a manner as to display the second additional image on the screen.

16. The method for controlling the display apparatus according to claim 11, further comprising an illuminance detection step of detecting ambient brightness of the display apparatus, wherein the determination step includes determining the range of display luminance settable in the setting step, using the brightness detected in the illuminance detection step and the size of the display area.

17. The method for controlling the display apparatus according to claim 11, further comprising a distance measurement step of measuring a distance between a user who is viewing the screen of the display apparatus and the screen, wherein the determination step includes determining the range of display luminance settable in the setting step, using the distance detected in the distance measurement step and the size of the display area.

18. A method for controlling a display apparatus including a display unit configured to display an image on a screen, the method comprising:
a setting step setting display luminance of the image to be displayed on the screen;
an acquisition step of acquiring an upper limit of a range of display luminance settable in the setting step;
a determination step of setting a size of a display area, in which the image is displayed, of the screen, using the upper limit of the range of display luminance acquired in the acquisition step; and
a control step of controlling the display unit in such a manner as to display the image in the display area set in the determination step, using the display luminance set in the setting step,
wherein the determination step includes setting the size of the display area to a first size upon the upper limit of the range of display luminance being a first luminance, and the determination step includes setting the size of the display area to a second size smaller than the first size upon the upper limit of the range of display luminance being a second luminance higher than the first luminance.
